(19) United States
(12) Patent Application Publication
(10) Pub. No.: US 2013/0011249 A1
(43) Pub. Date: Jan. 10, 2013

(54) MULTI-LAYER FILTER, GAS TURBINE INCLUDING A MULTI-LAYER FILTER, AND PROCESS OF FILTERING

(75) Inventors: Brad Aaron KIPPEL, Greenville, SC (US); Steve HINER, Alton Hants (GB)

(73) Assignee: GENERAL ELECTRIC COMPANY, Schenectady, NY (US)

(21) Appl. No.: 13/179,347

(22) Filed: Jul. 8, 2011

(51) Int. Cl. F01D 25/24; B01D 53/22; B01D 69/12

(52) U.S. Cl. 415/200; 96/11; 96/12; 95/45

(57) ABSTRACT

A multi-layer filter, a gas turbine including a multi-layer filter, and a process of filtering are disclosed. The multi-layer filter includes a nano-fiber layer positioned to receive an airflow, a coalescing base medium layer, and a membrane layer. The coalescing base medium and the membrane layer are positioned for the airflow to travel through the nano-fiber layer and the coalescing base medium layer, then through the membrane layer. The gas turbine includes an inlet and the multi-layer filter in a filter portion. The process includes positioning the multi-layer filter and directing an airflow through the multi-layer filter

### FIELD OF THE INVENTION

The present invention is directed to air filtration systems and processes. More particularly, the present invention relates to filters, systems including filters, and processes of filtering.

### BACKGROUND OF THE INVENTION

Generally, air filtration systems in gas turbines remove salt, dust, corrosives, moisture, and other undesirable substances from inlet air in order to prevent their entry into downstream components of the gas turbines. The moisture can be from, but not limited to, rain, fog, mist, water spray, and combinations thereof Known air filtration systems handle moisture and other undesirable substances by including multiple stages utilizing various known technologies. Filters may be used in one or more of these stages.

Use of multistage air filtration systems permits the undesirable substances, including moisture, to be removed. However, multistage filtration systems suffer from the drawbacks that they can be costly to implement and/or operate, they cannot be easily incorporated into existing systems such as gas turbines, they can include additional hardware taking additional space and/or increasing capital costs, and they also result in higher pressure inlet drop.

Known filters can include undesirable operational features. For example, filters may have a short usable life due to interaction between dirt, dust, hydrocarbons, and moisture choking off air permeability of the filter. Filters may fail to promote surface loading and therefore may be difficult to clean with self-cleaning systems, resulting in a short usable life. Filters may have a short usable life in high dust load environments. Filter media may be damaged during the manufacturing process, for example, pleat tips may be damaged, resulting in moisture passing through the filters.

A filter, a gas turbine inlet system including a filter, and a process of filtering that do not suffer from the above drawbacks would be desirable in the art.

### BRIEF DESCRIPTION OF THE INVENTION

In an exemplary embodiment, a multi-layer filter includes a nano-fiber layer positioned to receive an airflow, a coalescing base medium layer, and a membrane layer. The coalescing base medium layer and the membrane layer are positioned for the airflow to travel through the nano-fiber layer and the coalescing base medium layer, then through the membrane layer.

In another exemplary embodiment, a gas turbine inlet system includes a turbine section and an inlet portion. The turbine section includes a compressor positioned to receive an airflow from the inlet portion, a combustion system configured to receive the airflow from the compressor and to combust a fuel, and a turbomachine configured to be powered by the combustion of the fuel by the combustion system. The inlet portion is positioned to provide the airflow to the compressor. The inlet portion includes an air inlet and a filter portion having a multi-layer filter. The multi-layer filter includes a nano-fiber layer positioned to receive the airflow, a coalescing base medium layer, and a membrane layer. The coalescing base medium layer and the membrane layer are positioned for the airflow to travel through the nano-fiber layer and the coalescing base medium layer, then through the membrane layer to downstream components of the gas turbine.

In another exemplary embodiment, a process of filtering an airflow includes positioning a multi-layer filter, directing airflow through a nano-fiber layer of the multi-layer filter, through a coalescing base medium of the multi-layer filter, then through a membrane layer of the multi-layer filter, permitting moisture to pass through the nano-fiber layer, and coalescing moisture and hydrocarbons with the coalescing base medium.

Other features and advantages of the present invention will be apparent from the following more detailed description of the preferred embodiment, taken in conjunction with the accompanying drawings which illustrate, by way of example, the principles of the invention.

### BRIEF DESCRIPTION OF THE DRAWINGS

FIG. 1 is a schematic of a portion of a gas turbine having a multi-layer filter with a nano-fiber layer, a coalescing base medium layer, and a membrane layer.

FIG. 2 is a perspective view of a multi-layer filter with a nano-fiber layer, a coalescing base medium layer, and a membrane layer.

FIG. 3 is a perspective view of a multi-layer filter with a scrim layer, a nano-fiber layer, a coalescing base medium layer, and a membrane layer.

FIG. 4 is a perspective view of a multi-layer filter with a nano-fiber layer, a coalescing base medium layer, a membrane layer, and a scrim layer.

FIG. 5 is a perspective view of a multi-layer filter with a first scrim layer, a nano-fiber layer, a coalescing base medium layer, a membrane layer, and a second scrim layer.

Wherever possible, the same reference numbers will be used throughout the drawings to represent the same parts.

### DETAILED DESCRIPTION OF THE INVENTION

Provided is a multi-layer filter, a gas turbine inlet system including a multi-layer filter, and a process of filtering that do not suffer from one or more of the above drawbacks. Embodiments of the disclosure remove salt, dust, corrosives, moisture (for example, fluids containing water particles), and other undesirable substances from inlet air, prevent fouling of downstream components, permit operation in moist or hydrocarbon-laden conditions, have an extended usable life, promote surface loading in specific portions, are operable in high dust load environments, are capable of preventing damage such as at pleat tips, can be inexpensively implemented or operated, can be incorporated into existing gas turbine inlet systems, can operate without taking additional space, and combinations thereof.

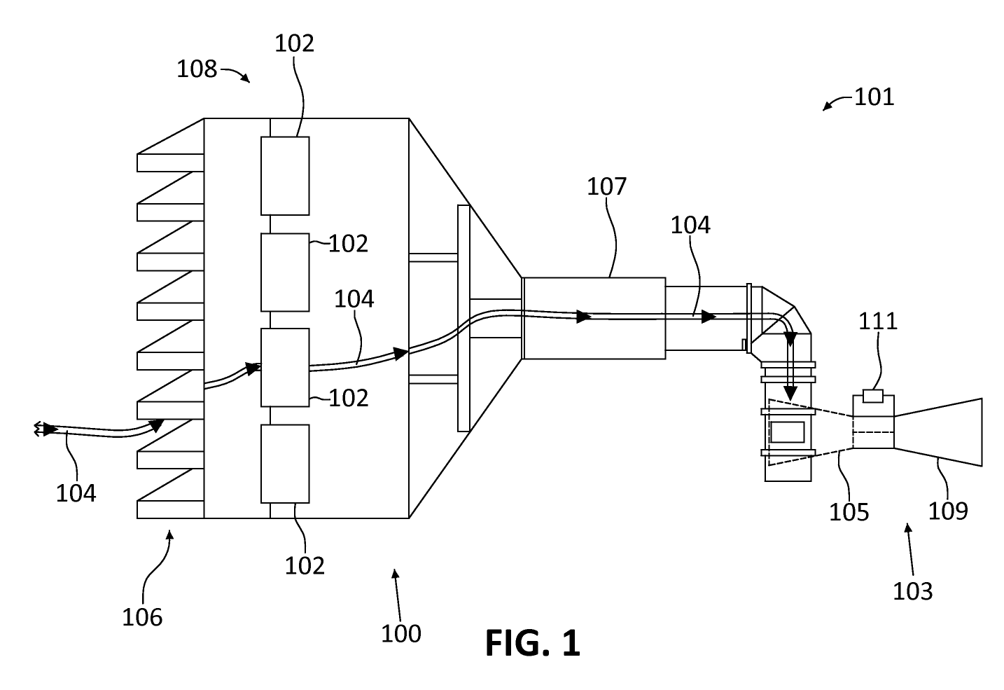

FIG. 1 shows an exemplary embodiment of a gas turbine inlet system 101. The gas turbine inlet system 101 includes a turbine section 103 including a compressor 105 positioned to receive an airflow 104 from an inlet portion 100, a combustion system 111 configured to receive the airflow 104 from the compressor 105 and to combust a fuel (not shown), and a turbomachine 109 configured to be powered by the combustion of the fuel by the combustion system 111.

The inlet portion 100 is positioned to provide the airflow 104 to the compressor 105. In one embodiment, the airflow 104 provides air to individual filters 102 capable of handling air between generally about 50 cubic feet per minute to about 5,000 cubic feet per minute with a face velocity between about 1 m/s and about 15 m/s during operation. As used herein, the term “air” refers to atmospheric gas and entrained substances including, but not limited to, moisture, dust, dirt, salt, hydrocarbons, and non-atmospheric gases. Although the gas turbine inlet system 101 is shown and described, it will be appreciated that other systems for receiving the airflow 104 may be used in conjunction with the inlet portion 100.

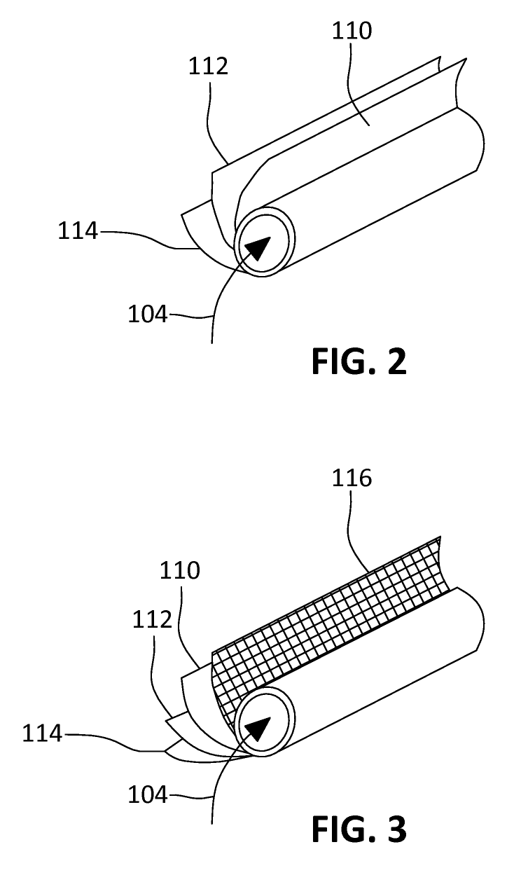

The inlet portion 100 includes a multi-layer filter 102 (for example, as shown in FIG. 2) for removing undesirable substances from the airflow 104. In other embodiments, the multi-layer filter 102 is used with other components operable in conjunction with the airflow 104. Other suitable components are portions of or include a generator air filter for gas turbines, a cement plant filter, a vehicle filter, a torrent line industrial filter for welding, industrial air handling filter for cleaning a manufacturing building, a large-scale air handling system, or other suitable systems. The airflow 104 is directed or drawn to inlet 106. The inlet 106 includes any suitable mechanism for directing and/or treating the air within the airflow 104. For example, suitable mechanisms include, but are not limited to, a weather hood, vane separator, moisture separator, drift eliminator, coalescing filter, and combinations thereof, for preventing additional moisture from entering the inlet 106, an anti-icing system for removing or eliminating ice, and a drainage system for removing water entering the inlet 106 or moisture condensed upon entering the inlet 106. Upon entering the inlet 106, the airflow 104 is directed to filter portion 108 where a portion or all of the airflow 104 is filtered by one or more of the multi-layer filters 102.

The filter portion 108 includes the multi-layer filter 102. The multi-layer filter 102 removes substances from the air within the airflow 104, thereby providing treated air to a duct 107 leading to downstream components such as a silencer (not shown) in the inlet portion 100. The multi-layer filter 102 can be a pocket filter, a V-cell mini pleat, a pleated cartridge, any other suitable filter, or combinations thereof. As shown in FIG. 2, in one embodiment, within the multi-layer filter 102, the airflow 104 travels through a nano-fiber layer 110 and a coalescing base medium layer 112, then downstream through a hydrophobic membrane layer 114. As used herein, the terms “downstream” and “upstream” refer to the position with respect to the direction of the airflow 104. Referring again to FIG. 1, for example, the airflow 104 travels downstream toward the duct 107 from an upstream position such as the inlet 106.

The nano-fiber layer 110 within the multi-layer filter 102 is positioned proximal to the inlet 106 and is configured to receive the airflow 104 from the inlet 106. Nano-fibers within the nano-fiber layer 110 are any suitable nano-fibers suspended within a material or arranged by any suitable technique. As used herein, the term “nano-fiber” refers to any fiber having a dimension that is on the order of nanometers (10⁻⁹ meters). Individually, the nano-fibers are visually indiscernible. For example, in embodiments of the present disclosure, the nano-fibers have a diameter of less than about 1500 nanometers, a diameter of less than about 100 nanometers, a diameter of less than about 50 nanometers, a diameter of less than about 10 nanometers, a diameter range of about 10 nanometers to about 1500 nanometers, a diameter range of about 10 nanometers to about 1000 nanometers, a diameter range of about 20 nanometers to about 500 nanometers, a diameter range of about 50 nanometers to about 500 nanometers, a diameter range of about 100 nanometers to about 500 nanometers, a diameter range of about 20 nanometers to about 400 nanometers, or a diameter range of about 40 nanometers to about 200 nanometers, the diameter being measured over a central 20%, 50%, 80%, or all of the nano-fiber, for example, as measured through image analysis tools coupled with electron microscopy. Additionally or alternatively, in embodiments of the present disclosure, the nano-fibers have dimensional variance of less than 20%, dimensional variance of less than 5%, or dimensional variance of less than 1% over the region of greatest variance.

In one embodiment, the nano-fiber layer 110 includes nano-fibers being formed into a suitable media. In one embodiment, the nano-fibers are formed into the nano-fiber layer 110 as a melt-blown web, melt-spinning, electro-spinning, or other suitable processes that form random webs of fiber. In one embodiment, the nano-fibers include a polymeric material such as, for example, homopolymers, copolymers (for example, block, graft, random, and alternating copolymers), polyethylene, polypropylene, terpolymers, polylactides, polyactic acids, polyeolefins, polyacrylonitrile, polyurethane, polycarbonate, polycaprolactone, polyvinyl alcohol, chitosan nylon, polystyrene, proteins, poly(diallyldimethylammonium chloride), polyacrylic acid, poly(allylamine hydrosulfate), poly(4-styrenesulfonic acid), poly(vinyl sulfate) potassium salt, 4-styrene sulfonic acid sodium salt hydrate, polystyrene sulfonate, polyethylene imine, straight chain polyethyleneimine backbones, a block copolymer of a block of straight chain polyethyleneimine backbones, a water soluble polymer block (for example, polyethylene glycol, polypropionylethyleneimine, and/or polyacrylamide), a hydrophobic polymer block (for example, polystyrene or polyoxazolines including polyphenyloxazoline, polyoctyloxazoline, and polydodecyloxazoline), polyacrylates (for example, polymethyl methacrylate and polybutyl methacrylate), and combinations thereof. In one embodiment, the nano-fibers include metal or other non-polymeric particles.

The media and/or the nano-fibers within the nano-fiber layer 110 are selected to provide desired properties for receiving the airflow 104. In one embodiment, the nano-fiber layer 110 promotes surface loading. In one embodiment, the nano-fiber layer 110 permits moisture to pass through the nano-fiber layer. In one embodiment, the nano-fiber layer 110 is bonded to the coalescing base medium layer 112. In this embodiment, the coalescing base medium layer 112 may form a portion of the media of the nano-fiber layer 110.

The coalescing base medium layer 112 within the multi-layer filter 102 is positioned upstream from the hydrophobic membrane layer 114. The coalescing base medium layer 112 provides moisture and hydrocarbon coalescing and/or draining, as well as burst strength. As used herein, the term “coalescing” refers to forming large drops of moisture from smaller drops and/or from mist. In one embodiment, the coalescing base medium layer 112 is configured for depth loading. In one embodiment, the coalescing base medium layer 112 is a spun bond melt-blown web. In one embodiment where the coalescing base medium layer 112 does not form the portion of the media of the nano-fiber layer 110, the coalescing base medium layer 112 forms a separate layer adjacent to the nano-fiber layer 110. In this embodiment, the coalescing base medium layer 112 also includes a polymeric material such as, for example, homopolymers, copolymers (for example, block, graft, random, and alternating copolymers), terpolymers, polylactides, polyactic acids, polyeolefins, polyacrylonitrile, polyurethane, polycarbonate, polycaprolactone, polyvinyl alcohol, cellulose, chitosan nylon, polystyrene, proteins, poly(diallyldimethylammonium chloride), polyacrylic acid, poly(allylamine hydrosulfate), poly(4-styrenesulfonic acid), poly(vinyl sulfate) potassium salt, 4-styrene sulfonic acid sodium salt hydrate, polystyrene sulfonate, polyethylene imine, straight chain polyethyleneimine backbones, a block copolymer of a block of straight chain polyethyleneimine backbones, a water soluble polymer block (for example, polyethylene glycol, polypropionylethyleneimine, and/or polyacrylamide), a hydrophobic polymer block (for example, polystyrene or polyoxazolines including polyphenyloxazoline, polyoctyloxazoline, and polydodecyloxazoline), polyacrylates (for example, polymethyl methacrylate and polybutyl methacrylate), and combinations thereof.

The hydrophobic membrane layer 114 within the multi-layer filter 102 is positioned proximal to the duct 107. The hydrophobic membrane layer 114 converts the air in the airflow 104 into air having predetermined particulate properties. For example, in one embodiment, the filter permits formation of a high efficiency particulate air (HEPA) by having an integral value of about 85%, 95%, or 99.95% filtration efficiency at the most penetrating particle size, an integral value of about 0.05% penetration, a local value of about 99.75% filtration efficiency, and a local value of about 0.25% penetration. In a further embodiment, the filter permits formation of HEPA by having an integral value of about 99.995% filtration efficiency, an integral value of about 0.005% penetration, a local value of about 99.975% filtration efficiency, and a local value of about 0.025% penetration. In one embodiment, the membrane layer 114 includes or is polytetrafluoroethylene, expanded polytetrafluoroethylene, and/or polyethylene. In one embodiment, the membrane layer 114 is hydrophobic or oleophobic.

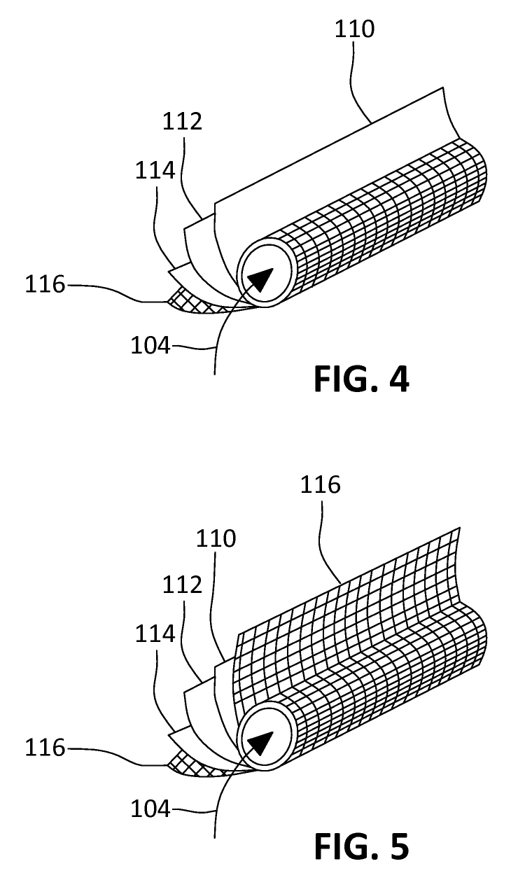

In one embodiment, multi-layer filter 102 further includes one or more scrim layers 116. As used herein, the term “scrim layer” refers to a processing aid structure having the capability to break up surface tension, for example, in water, so that the water is less likely to bead on a surface. The one or more scrim layers 116 change the topography of the surface. In one embodiment, with the one or more scrim layers 116 positioned upstream, the one or more scrim layers 116 are on the nano-scale. In one embodiment, with the one or more scrim layers 116 positioned downstream, the one or more scrim layers 116 form a protective but sacrificial layer, thereby providing additional strength. Referring to FIG. 3, in one embodiment, the multi-layer filter 102 includes the scrim layer 116 being positioned proximal to the nano-fiber layer 110 such that the airflow 104 travels through the scrim layer 116 then downstream through the nano-fiber layer 110, the coalescing base medium layer 112, and the hydrophobic or oleophobic membrane layer 114. In this embodiment, the scrim layer 116 provides mist protection for the nano-fiber layer 110. Referring to FIG. 4, in one embodiment, the multi-layer filter 102 includes the scrim layer 116 proximal to the hydrophobic or oleophobic membrane layer 114 such that the airflow 104 travels through the nano-fiber layer 110, the coalescing base medium layer 112, and the hydrophobic or oleophobic membrane layer 114, then the scrim layer 116. In this embodiment, the scrim layer 116 reduces or eliminates damage of the membrane layer 114 due to pleating, thereby resulting in a hydrophobic or oleophobic layer. Referring to FIG. 5, in one embodiment, the multi-layer filter 102 includes two scrim layers 116 positioned on opposing surfaces of the multi-layer filter 102. In this embodiment, a first scrim layer 116 is positioned proximal to the nano-fiber layer 110 and a second scrim layer 116 is positioned proximal to the hydrophobic or oleophobic membrane layer 114. The airflow 104 travels downstream through the first scrim layer 116, then through the nano-fiber layer 110, the coalescing base medium layer 112, and the hydrophobic or oleophobic membrane layer 114, then through the second scrim layer 116.

While the invention has been described with reference to a preferred embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A multi-layer filter, comprising:
a nano-fiber layer positioned to receive an airflow;
a coalescing base medium layer; and
a membrane layer;
wherein the coalescing base medium layer and the membrane layer are positioned for the airflow to travel through the nano-fiber layer and the coalescing base medium layer, then through the hydrophobic membrane layer.

2. The filter of claim 1, wherein the nano-fiber layer is arranged and disposed to promote surface loading.

3. The filter of claim 1, wherein the nano-fiber layer is arranged and disposed to permit moisture to pass through the nano-fiber layer.

4. The filter of claim 1, wherein the nano-fiber layer is bonded to the coalescing base medium layer.

5. The filter of claim 1, wherein the coalescing base medium layer is configured for depth loading and burst strength.

6. The filter of claim 1, wherein the coalescing base medium layer coalesces water and hydrocarbons.

7. The filter of claim 1, wherein the hydrophobic membrane layer includes polytetrafluoroethylene, expanded polytetrafluoroethylene, or polyethylene.

8. The filter of claim 1, wherein the membrane layer is hydrophobic.

9. The filter of claim 1, wherein the membrane layer provides filtration efficiency of at least 85% at the most penetrating particle size, an integral value of about 0.05% penetration, a local value of about 99.75% filtration efficiency, and a local value of about 0.25% penetration.

10. The filter of claim 1, further comprising a scrim layer, wherein the scrim layer is positioned for the airflow to travel through the scrim layer then the nano-fiber layer.

11. The filter of claim 1, further comprising a scrim layer, wherein the scrim layer is positioned for the airflow to travel through the membrane layer then the scrim layer.

12. The filter of claim 1, further comprising a first scrim layer and a second scrim layer, the first scrim layer being positioned proximal to the nano-fiber layer and the second scrim layer being positioned proximal to the membrane layer.

13. The filter of claim 1, wherein the airflow is within a gas turbine inlet system.

14. A gas turbine inlet system, comprising:
a turbine section, comprising:
a compressor positioned to receive an airflow from an inlet portion;
a combustion system configured to receive the airflow from the compressor and to combust a fuel; and
a turbomachine configured to be powered by the combustion of the fuel by the combustion system;
an inlet portion positioned to provide the airflow to the compressor, the inlet portion comprising:
an air inlet;
a filter portion, the filter portion having a multi-layer filter, the multi-layer filter comprising;
a nano-fiber layer positioned to receive the airflow;
a coalescing base medium layer; and
a membrane layer;
wherein the coalescing base medium layer and the hydrophobic membrane layer are positioned for the airflow to travel through the nano-fiber layer and the coalescing base medium layer, then through the membrane layer to downstream components of the gas turbine.

15. The turbine inlet system of claim 14, wherein the membrane layer is hydrophobic.

16. The turbine inlet system of claim 14, wherein the membrane layer is oleophobic.

17. The turbine inlet system of claim 14, wherein the coalescing base medium layer coalesces one or more of moisture and hydrocarbons.

18. The turbine inlet system of claim 14, wherein the coalescing base medium layer is configured for depth loading and burst strength.

19. The turbine inlet system of claim 14, wherein the hydrophobic membrane layer includes polytetrafluoroethylene, expanded polytetrafluoroethylene, or polyethylene.

20. A process of filtering an airflow, the process comprising:
positioning a multi-layer filter, the multi-layer filter comprising:
a nano-fiber layer positioned to receive an airflow;
a coalescing base medium layer; and
a membrane layer;
directing the airflow through the nano-fiber layer, through the coalescing base medium layer, then through the membrane layer;
permitting moisture to pass through the nano-fiber layer; and
coalescing one or more of the moisture and hydrocarbons with the coalescing base medium layer.
